(19) United States
(12) Patent Application Publication
(10) Pub. No.: US 2002/0172419 A1
(43) Pub. Date: Nov. 21, 2002

(54) Image enhancement using face detection

(76) Inventors: Qian Lin, Santa Clara, CA (US); Clayton Brian Atkins, Mountain View, CA (US); Daniel Tretter, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 09/854,580

(22) Filed: May 15, 2001

(51) Int. Cl. G06K 9/00; G03B 15/03; G06K 9/40

(52) U.S. Cl. 382/167; 382/274; 396/158

(57) ABSTRACT

An image enhancement apparatus and a corresponding method use face detection to provide for automatic enhancement of appearances of an image based on knowledge of human faces in the image. By modifying and transforming the image automatically using facial information, the image, including the human faces in the image, may have more pleasing lightness, contrast, and/or color levels. The image enhancement method may also automatically reduce or remove any red eye artifact without human intervention, leading to images with more pleasing appearances.

### TECHNICAL FIELD

The technical field relates to image enhancement, and, in particular, to image enhancement using face detection.

### BACKGROUND

Appearances of faces in images have strong impact on how the images are perceived. Since many images are acquired with faces too bright or too dark, or with a red eye artifact resulting from flashes, image enhancement techniques are becoming increasingly important.

Traditional methods for image enhancement typically work by modifying lightness, contrast, or color levels to improve image appearance. However, such methods typically work using only lower-level image attributes. For example, the well-known method of histogram equalization uses only image histogram. Moreover, such traditional methods may require human involvement during and as part of the image enhancement process, with the human controlling the levels of modification.

Traditional red eye removal techniques typically require a user to click on or near eyes in an image that exhibit the red eye artifact, in other words, user interaction is typically required.

### SUMMARY

An image enhancement method using face detection provides for automatic detection of human faces in an image using face detection algorithms and automatic enhancement of appearances of the image based on knowledge of faces in the image.

In an embodiment, the image enhancement method may automatically enhance lightness, contrast, or color levels of the human faces.

In another embodiment, the image enhancement method may automatically locate the human faces in the image, locate eyes in the human faces, and reduce or remove any red eye artifact from the human faces.

In yet another embodiment, the image enhancement method may use mapping techniques to produce an image with target levels for a mean value and/or a variation value, such as a standard deviation, in the face regions. The mapping may modify the faces alone or may modify the entire image.

### DESCRIPTION OF THE DRAWINGS

The preferred embodiments of an image enhancement method using face detection will be described in detail with reference to the following figures, in which like numerals refer to like elements, and wherein:

FIG. 1 illustrates exemplary hardware components of a computer that may be used to implement the image enhancement method using face detection;

FIG. 2(a) illustrates a first exemplary image enhancement method using lightness mapping;

FIG. 2(b) illustrates a second exemplary image enhancement method using lightness mapping; and

FIG. 3 is a flow chart of an exemplary image enhancement method using face detection.

### DETAILED DESCRIPTION

An image enhancement apparatus and a corresponding method use face detection to provide for automatic enhancement of appearances of an image based on knowledge of human faces in the image. By modifying and transforming the image automatically using facial information, the image, including the human faces in the image, may have more pleasing lightness, contrast, and/or color levels. The image enhancement method may also automatically reduce or remove any red eye artifact without human intervention, leading to images with more pleasing appearances.

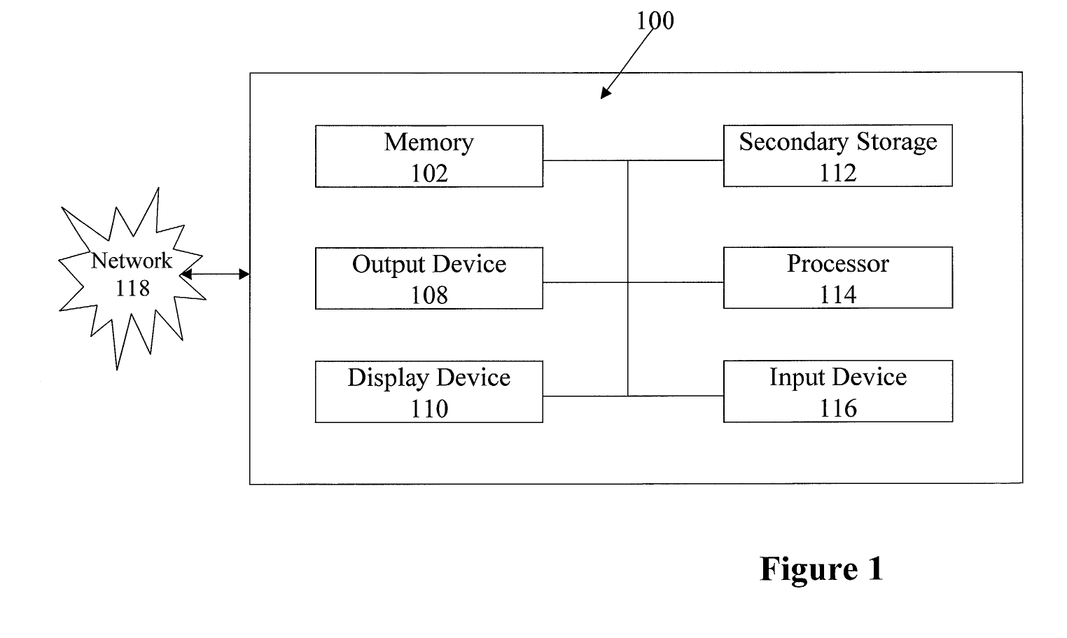

FIG. 1 illustrates exemplary hardware components of a computer 100 that may be used to implement the image enhancement method using face detection. The computer 100 includes a connection with a network 118 such as the Internet or other type of computer or phone networks. The computer 100 typically includes a memory 102, a secondary storage device 112, a processor 114, an input device 116, a display device 110, and an output device 108.

The memory 102 may include random access memory (RAM) or similar types of memory. The computer 100 may be connected to the network 118 by a web browser. The web browser makes a connection via the WWW to other computers known as web servers, and receives information from the web servers that is displayed on the computer 100. The secondary storage device 112 may include a hard disk drive, floppy disk drive, CD-ROM drive, or other types of non-volatile data storage, and may correspond with various databases or other resources. The processor 114 may execute information stored in the memory 102, the secondary storage 112, or received from the Internet or other network 118. The input device 116 may include any device for entering data into the computer 100, such as a keyboard, key pad, cursor-control device, touch-screen (possibly with a stylus), or microphone. The display device 110 may include any type of device for presenting visual image, such as, for example, a computer monitor, flat-screen display, or display panel. The output device 108 may include any type of device for presenting data in hard copy format, such as a printer, and other types of output devices including speakers or any device for providing data in audio form. The computer 100 can possibly include multiple input devices, output devices, and display devices.

Although the computer 100 is depicted with various components, one skilled in the art will appreciate that the computer 100 can contain additional or different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 100 to perform a particular method.

After an image, such as a photograph or a digital image, is inputted into the memory 102 through the input device 116, the secondary storage 112, or other means, the processor 114 may automatically detect and locate faces, typically human faces, in the image using face detection algorithms. Human faces have distinctive appearances, and the face detection algorithms typically use lightness information to detect and locate faces in an image by extracting out a lightness version of the image. The processor 114 may further locate components of the faces, such as eyes. The automatic location of eyes in the faces may enable automatic red eye reduction or removal (described later).

Examples of the face detection algorithms are described, for example, in Rowley, Baluja, and Kanade, “Neural Network-Based Face Detection,” IEEE Transactions on Pattern Analysis and Machine Intelligence, Vol. 20, No. 1, January 1998; Sung and Poggio, “Example-Based Learning for View-Based Human Face Detection,” IEEE Transactions on Pattern Analysis and Machine Intelligence, Vol. 20, No. 1, January 1998; and U.S. Pat. No. 5,642,431, issued to Poggio and Sung, entitled “Network-Based System and Method for Detection of Faces and the Like”, which are incorporated herein by reference.

“Neural Network-Based Face Detection” presents a neural network-based face detection system. A retinally connected neural network examines small windows of an image, and decides whether each window contains a face. The system arbitrates among multiple networks to improve performance over a single network. A bootstrap algorithm is used for training the networks, which adds false detections into the training set as training progresses. This eliminates the difficult task of manually selecting non-face training examples, which must be chosen to span the entire space of non-face images.

“Example-Based Learning for View-Based Human Face Detection” presents an example-based learning approach for locating vertical frontal views of human faces in complex scenes. The technique models the distribution of human face patterns by means of a few view-based “face” and “nonface” model clusters. At each image location, a difference feature vector is computed between the local image pattern and the distribution-based model. A trained classifier determines, based on the difference feature vector measurements, whether or not a human face exists at the current image location. The article shows empirically that a distance metric adopted for computing difference feature vectors, and the “nonface” clusters included in the distribution-based model, are both critical for the success of the system.

U.S. Pat. No. 5,642,431 discloses a network-based system and method for analyzing images to detect human faces using a trained neural network. Because human faces are essentially structured objects with the same key features geometrically arranged in roughly the same fashion, U.S. Pat. No. 5,642,431 defines a semantically stable “canonical” face pattern in the image domain for the purpose of pattern matching.

As an example, the processor 114 may detect human faces by scanning an image for such canonical face-like patterns at all possible scales. The scales represent how coarsely the image is represented in the computer memory 102. At each scale, the applied image is divided into multiple, possibly overlapping sub-images based on a current window size. At each window, the processor 114 may attempt to classify the enclosed image pattern as being either a face or not a face. Each time a face window pattern is found, the processor 114 may report a face at the window location, and the scale as given by the current window size. Multiple scales may be handled by examining and classifying windows of different sizes or by working with fixed sized window patterns on scaled versions of the image. Accordingly, in an image where people are scattered so there are faces of different sizes, the face detection algorithm, using the processor 114, may find every face in the image.

Although the image enhancement method using face detection is described using the face detection algorithms described above, one skilled in the art will appreciate that other face detection methods may be used in connection with the image enhancement.

After the faces are detected and located in the image, the image enhancement method may automatically modify the image using, for example, mapping techniques, so that the image may have preferred appearances, i.e., with more appealing lightness, contrast, and/or color levels, for example, and without any red eye artifact.

At least one study has shown that people prefer to look at images, such as photographs and digital images, with certain levels of lightness and contrast, i.e., there are desirable levels for a mean value and/or a variation value, such as a standard deviation, of the pixel values in the face region. Using, for example, mapping techniques, the image enhancement method may modify an image so that an output of the mapping may produce the image with the desirable levels for the mean value and/or the standard deviation of the pixels in the face region.

Lightness level in a color image is a component of the image that lends the perception of brightness. The image enhancement method will be described with respect to color images; however, one skilled in the art will appreciate that the method may equally be applied for processing monochrome images, as well as images represented with other color schemes, for example, sepia tone.

An embodiment of the image enhancement method may add or subtract a fixed amount to the lightness component of each pixel in the image. Adding may lead to a brighter image, while subtracting may lead to a darker image. The processor 114 may select the fixed amount to be added or subtracted to produce an image with a target mean lightness level of the pixels in the face region.

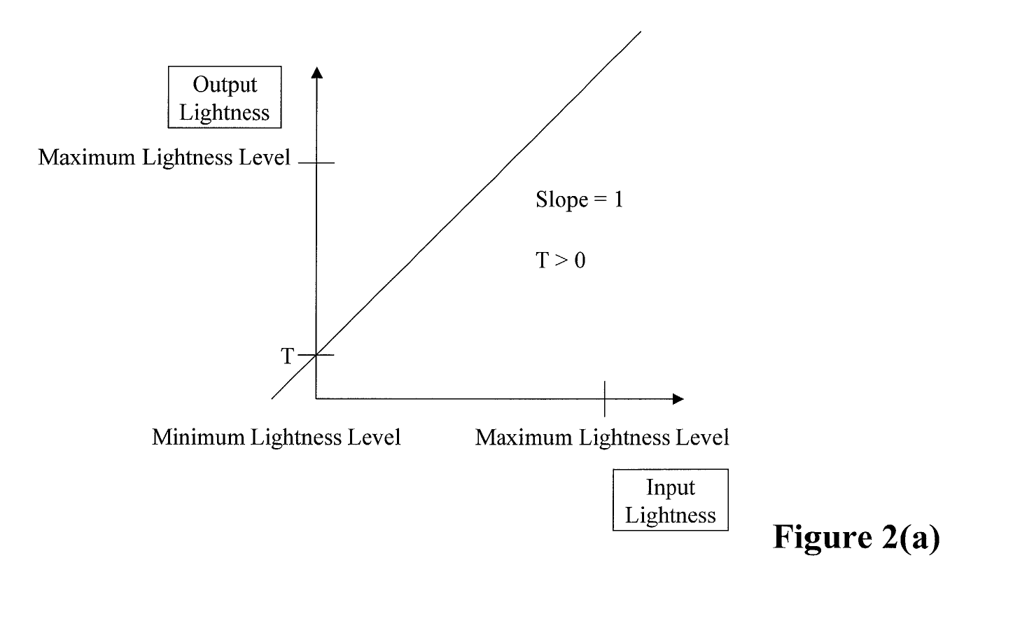

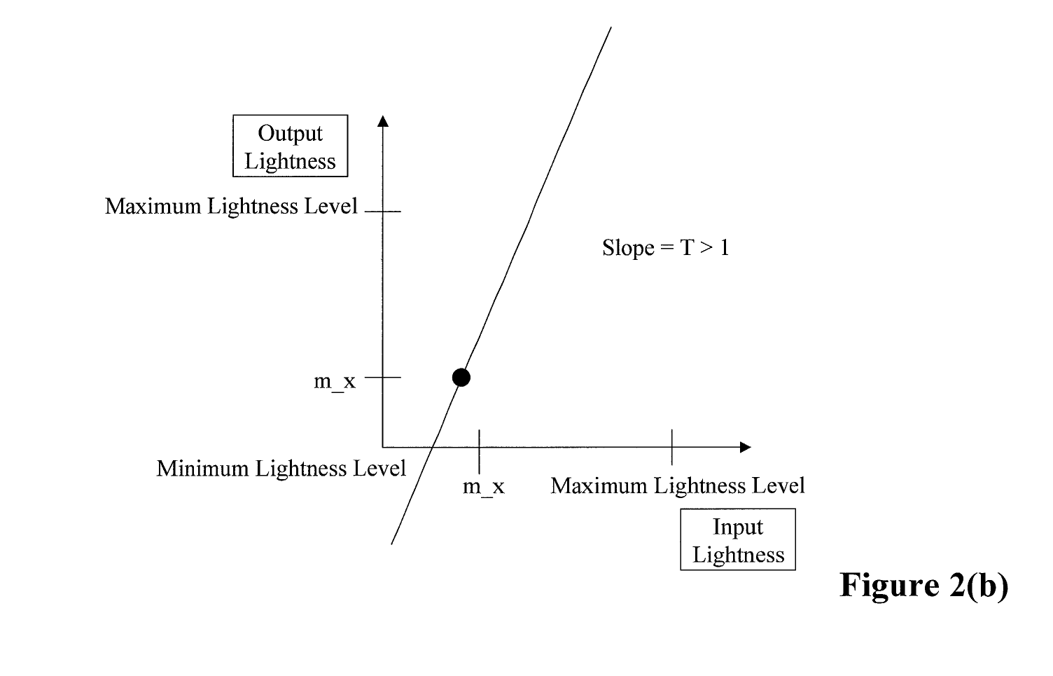

For example, x_{f} may be the face pixels in an input image, where the symbol f represents a set of pixel locations recognized as being part of the face regions identified by the face detection algorithm. Suppose the mean of x_{f} is mₓ, and a transformation is preferred to ensure the mean of the face pixels in an output image is mₜ. The pixels in the output image may be denoted with the letter y. In this example, the fact that pixel values usually have maximal and minimal levels, for example, 0 and 255, is ignored. In other words, “clipping” is ignored. The lightness transformation may use the following formula: y=x+T, where T=mₜ−mₓ. Since the average of x_{f} is mₓ, the average of y is m_{y}=mₓ+mₜ−mₓ=mₜ. FIG. 2(a) illustrates the lightness transformation.

Another embodiment of the image enhancement method may keep the mean of the lightness of the face pixels the same, and modify the standard deviation of the lightness of the face pixels with a fixed multiplicative factor. Similarly, the processor 114 may select the multiplicative factor that yields the desired level of variation. Following the notation of the above example, and again ignoring “clipping”, the standard deviation of the face pixels in an input image may be written as σₓ. A target standard deviation may be referred to as σₜ. The contrast transformation may use the following formula: y=Tx+(1−T)mₓ, where

$$T = \sqrt{\frac{{σ}_{t}^{2}}{{σ}_{x}^{2}}} .$$

This contrast transformation ensures that an output image may have the target standard deviation σₜ. FIG. 2(b) illustrates the contrast transformation.

Even though the image enhancement method is described using the mapping technique described above, one skilled in the art will appreciate that other image enhancement techniques, which work by modifying lightness, contrast, and/or color levels, may be utilized in connection with the face detection mechanism.

The face detection algorithms described above typically further indicates the location of certain components of faces in an image, for example, eyes. Accordingly, the image enhancement method may further automatically reduce or remove any red eye artifact without human involvement, by simply passing the location of the eyes to red eye removal softwares stored in the memory 102 or the secondary storage device 112.

The red eye artifact is a common artifact found in a photograph of a person or animal, especially when a flashbulb without a preflash is used when taking the photograph. The red eye artifact, typically appearing as a red spot or halo obscuring all or part of the pupil of each eye, is typically produced when the pupil is sufficiently dilated to allow a noticeable amount of light from a source light to reflect off the back of the eye. In humans, the reflection is typically a reddish color or other colors.

The image enhancement method may, after locating the eyes in the image, automatically determine if there is any red eye artifact in an image, and if yes, reduce or remove the red eye artifact from the human face without user interaction using the red eye removal technique. The red eye artifact may be reduced or removed by, for example, removing the redness in the eyes, making the eyes dark, or both. The red eye removal technique, traditionally requiring human involvement in clicking on the location in the image where the eyes are, is a well known digital image process.

An example of a red eye removal technique is described in U.S. Pat. No. 6,016,354, issued to Lin et. al., entitled “Apparatus and a Method for Reducing Red-Eye in a Digital Image,” which is incorporated hereinby reference. U.S. Pat. No. 6,016,354 discloses an apparatus and method for editing a digital color image to remove discoloration of the image, known as a “red eye” effect, by parsing the discoloration into regions and re-coloring the area of the discoloration based on the attributes of the discoloration. The editing process automatically creates a bitmap that is a correction image, which is composited with the source image or a copy of it and displayed as the source image with the red eye artifact corrected.

One skilled in the art will appreciate that other techniques for reducing or removing a red eye artifact may be used in connection with the image enhancement method using face detection to produce an enhanced image. After the image has been modified and enhanced, the image may be outputted through the output device 108 or the display device 110.

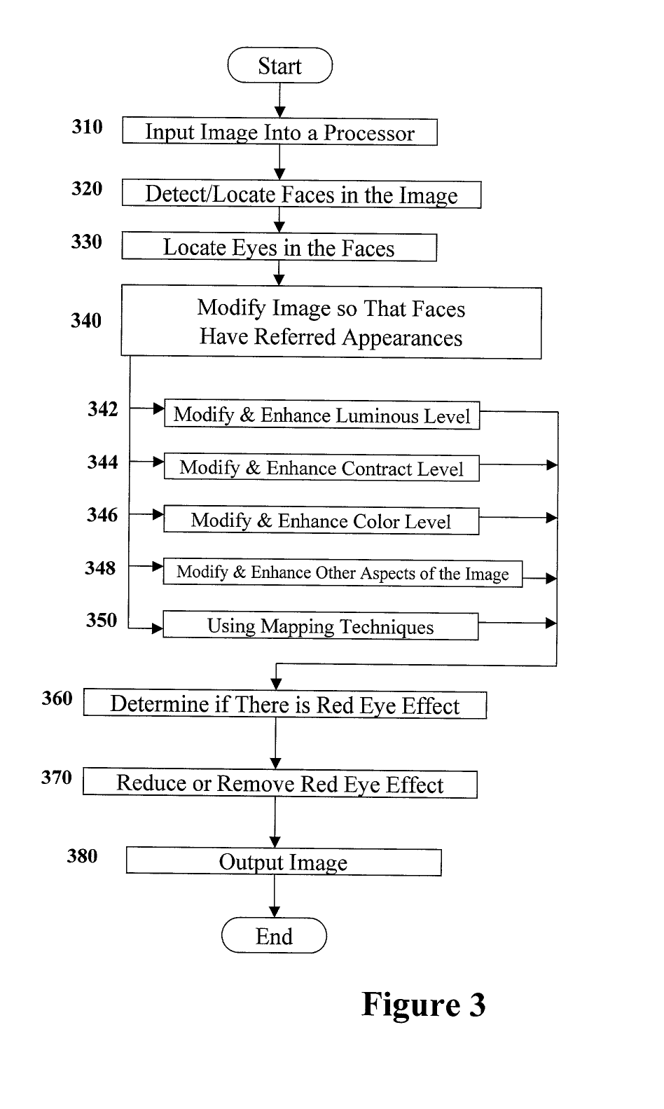

FIG. 3 is a flow chart of an exemplary image enhancement method using face detection. This method may be implemented, for example, in software modules for execution by processor 114. After an image, such as a color photograph or a digital image, is inputted into a processor 114, step 310, face detection algorithms may be used to automatically detect and locate human faces in the image, step 320. The face detection algorithms may also locate eyes in the human faces automatically for red eye reduction or removal, step 330. Next, image enhancement techniques may be used to automatically modify the image so that human faces may have preferred appearances, step 340. The image enhancement may include enhancing lightness levels, step 342, enhancing contrast levels, step 344, enhancing color levels of the human faces, step 346, or enhancing other aspects of the image, step 348, to make the faces more appealing. The image enhancement technique may use mapping technique to process the image, step 350, i.e., determine mapping required to produce a more appealing image, so that when the mapping is completed, an output of the mapping may produce an image with the mean value and/or the standard deviation in the face regions achieving certain preferred target levels. The mapping may modify the faces alone or may modify the entire image. Finally, if any red eye artifact is determined to exist, step 360, the image enhancement method may automatically reduce or remove the red eye artifact from the faces, step 370. After the image is modified and enhanced, the image may be outputted through the output device 108 or the display device 110.

While the image enhancement method has been described in connection with an exemplary embodiment, it will be understood that many modifications in light of these teachings will be readily apparent to those skilled in the art, and this application is intended to cover any variations thereof.

What is claimed is:

1. An image enhancement method using face detection algorithms, comprising:
automatically detecting human faces in an image using face detection algorithms;
automatically locating the human faces in the image; and
automatically enhancing an appearance of the image based on the human faces in the image.

2. The method of claim 1, wherein the enhancing step includes automatically enhancing lightness levels of the human faces.

3. The method of claim 1, wherein the enhancing step includes automatically enhancing contrast levels of the human faces.

4. The method of claim 1, wherein the enhancing step includes automatically enhancing color levels of the human faces.

5. The method of claim 1, wherein the locating step includes automatically locating eyes in the human faces.

6. The method of claim 5, wherein the enhancing step comprises:
automatically determining if there exists a red eye artifact; and
reducing or removing the red eye artifact from the human faces.

7. The method of claim 1, wherein the enhancing step includes using a mapping technique to produce the image with target levels for a mean value or a variation value.

8. An apparatus for enhancing an image using face detection algorithms, comprising:
a module for automatically detecting human faces in an image using face detection algorithms;
a module for automatically locating the human faces in the image; and
a module for automatically enhancing an appearance of the image based on the human faces in the image.

9. The apparatus of claim 8, wherein the image is a digital image.

10. The apparatus of claim 8, wherein the module for enhancing the appearances of the image includes a module for automatically enhancing lightness levels of the human faces.

11. The apparatus of claim 8, wherein the module for enhancing the appearances of the image includes a module for automatically enhancing contrast levels of the human faces.

12. The apparatus of claim 8, wherein the module for enhancing the appearances of the image includes a module for automatically enhancing color levels of the human faces.

13. The apparatus of claim 8, wherein the module for locating the human faces includes a module for automatically locating eyes in the human faces.

14. The apparatus of claim 13, wherein the module for enhancing the appearances of the image comprises:
a module for automatically determining if there exists a red eye artifact; and
a module for reducing or removing the red eye artifact from the human faces.

15. A computer readable medium comprising instructions for image enhancement using face detection, the instructions comprising:
automatically detecting human faces in an image using face detection algorithms;
automatically locating the human faces in the image; and
automatically enhancing an appearance of the image based on the human faces in the image.

16. The computer readable medium of claim 15, wherein the instructions for enhancing the appearance of the image include automatically enhancing lightness levels of the human faces.

17. The computer readable medium of claim 15, wherein the instructions for enhancing the appearance of the image include automatically enhancing contrast levels of the human faces.

18. The computer readable medium of claim 15, wherein the instructions for enhancing the appearance of the image includes automatically enhancing color levels of the human faces.

19. The computer readable medium of claim 15, wherein the instructions for locating the human faces include automatically locating eyes in the human faces.

20. The computer readable medium of claim 19, wherein the instructions for enhancing the appearance of the image comprises:
automatically determining if there exists a red eye artifact; and
reducing or removing the red eye artifact of the human faces.
